(19) United States
(12) Patent Application Publication
(10) Pub. No.: US 2025/0382163 A1
(43) Pub. Date: Dec. 18, 2025

(54) METHODS AND APPARATUS FOR A PORTABLE ASSEMBLY JIG

(71) Applicant: The Boeing Company, Arlington, VA (US)

(72) Inventor: Chester James Hill, IV, Grafton, IL (US)

(21) Appl. No.: 18/746,996

(22) Filed: Jun. 18, 2024

(51) Int. Cl. B66F 5/00; B62B 5/04

(52) U.S. Cl. CPC B66F 5/00; B62B 5/049

(57) ABSTRACT

Systems, apparatus, articles of manufacture, and methods are disclosed for a portable assembly jig including: a frame having a top side and a bottom side, the top side including structure to support an object, the bottom side defining at least three support locations to fully support the assembly jig in a parked condition, assembly of the object occurs in the parked condition; casters coupled to the frame enable movement of the frame in a portable condition; a jack coupled to at least one of the three support locations such that extension of a foot of the jack toward a ground surface causes at least one of the casters to be above the ground surface and the assembly jig to be in the parked condition; and at least one stabilizer foot coupled to the frame, a first stabilizer foot to stabilize the frame in the parked condition.

### GOVERNMENT INTEREST

This invention was made with Government support under contract No. 18-D-0107/22-F-1004 awarded by the Department of Defense (DOD). The Government has certain rights in this invention.

### FIELD OF THE DISCLOSURE

This disclosure relates generally to the assembly of an object and, more particularly, to a portable assembly jig to aid the assembly of the object.

### BACKGROUND

In recent years, assembly of an object has been effectuated by bases that are embedded in the factory floor and precisely laid so that each base permits reestablishment of the associated datum reference plane. Therefore, an object for assembly placed on top of the base is level. When the object for assembly is desired in another location, another set of bases must be used and placed in another location to enable reestablishment of the associated datum reference plane. When the object for assembly is moved to another location, the datum reference plane is reestablished to enable repeatability at that usage location.

### BRIEF DESCRIPTION OF THE DRAWINGS

FIG. 1 is a diagram of a side view of an example assembly jig.

FIG. 2 is a front view of the example assembly jig of FIG. 1.

FIG. 3 is a side perspective view of the example assembly jig of FIGS. 1 and 2.

FIG. 4 is a bottom perspective view of an example assembly jig of FIGS. 1-3.

FIG. 5 is a flowchart of an example method of operation of the assembly jig of FIGS. 1-4.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### SUMMARY

An example portable assembly jig for facilitating assembly of an object includes a frame, casters, a jack, and at least one stabilizer foot coupled to the frame. The frame has a top side and a bottom side. The top side includes structure to support an object being assembled. The bottom side defines at least three support locations. The at least three support locations are to fully support a weight of the assembly jig in a parked condition. The assembly of the object is to occur in the parked condition. The casters are coupled to the frame to enable movement of the frame in a portable condition. The jack is coupled to at least one of the three support locations such that extension of a foot of the jack toward a ground surface on which the assembly jig is located causes at least one of the casters to be above the ground surface and the assembly jig to be in the parked condition. The at least one stabilizer foot is coupled to the frame. A first stabilizer foot extends to contact the ground surface in the parked condition to stabilize the frame relative to the ground surface.

An apparatus to facilitate assembly of an object includes a frame, a jack, and at least one means for stabilizing. The frame has a top side and a bottom side. The top side includes structure to support the object being assembled. The bottom side defines three support locations to fully support a weight of the apparatus during assembly of the object. The jack is coupled to at least one of the three support locations such that extension of a portion of the jack toward a ground surface on which the apparatus is located causes the frame to be raised relative to the ground surface. The at least one means for stabilizing coupled to the frame. A first means for stabilizing is to extend to contact the ground surface to stabilize the frame relative to the ground surface.

An apparatus to facilitate assembly of an object includes a fixture, casters, a jack, and at least one support. The fixture has a top side and a bottom side. The top side including structure to support the object being assembled. The bottom side including at least three support points. The casters coupled to the fixture to enable movement of the fixture. The jack coupled to at least one of the three support points such that extension of the jack toward a surface on which the fixture is located causes at least one of the casters to be above the surface, wherein the three support points support an entire weight of the fixture after extension of the jack. The at least one support is coupled to the fixture. A first support is to extend to contact the surface after extension of the jack to stabilize the fixture relative to the surface.

### DETAILED DESCRIPTION

In recent years, factory appurtenances (e.g., bases, etc.) have been used to reestablish the portable assembly jig datum reference plane at a planned assembly jig usage location. As used herein, a datum reference plane establishes a consistent coordinate system that defines an object's geometric features. In some examples, a datum reference plane may be established by three perpendicular axes relative to a reference point (e.g., the object, the ground, etc.) to form a basis for measurements from the reference point. These bases impose a high demand on cost, complexity, maintenance, and floor space. These bases have been used to produce a planar, level support for assembly of an object. Bases are mounted to the factory floor and require precise measurements during installation to ensure that each base permits reestablishment of the associated assembly jig datum reference plane. Due to mounting to the floor, bases are not easily portable and another set must be replaced in the factory floor to allow assembly in another location.

Further, deformation of the base on which the object is assembled occurs over time. Deformation can occur as a result of the base being placed on a factory floor that is not flat, placed at an angle in relation to another base, and/or configured to hold heavy and/or unequal weight for a period of time. Deformation of the base produces errors in measurements and assembly. Over time, the base can distort out of tolerance and result in unsuitable repeatability of measurements. Currently, as base deformation occurs, corrections are calculated and applied to ensure that the assembly of the object accounts for the errors produced by the distortion. Accordingly, additional steps are taken to validate the corrections to ensure against further assembly distortion. Therefore, base deformation results in the addition of calculation and validation steps to ensure accurate assembly using the distorted base.

There exists a need for a portable assembly jig that produces a repeatable plane for the assembly of an object. The assembly jig can be moved around the factory floor to allow for dynamic adjustment to factory floor conditions, such as, the angle of the floor, the height of the object for assembly, etc. Further, support implements (e.g., stabilizer feet, support locations, casters, etc.) are utilized to prevent distortion of the frame of the assembly jig. Therefore, the assembly jig is movable and provides a repeatable plane for assembly of the object that is adjustable in response to operating conditions.

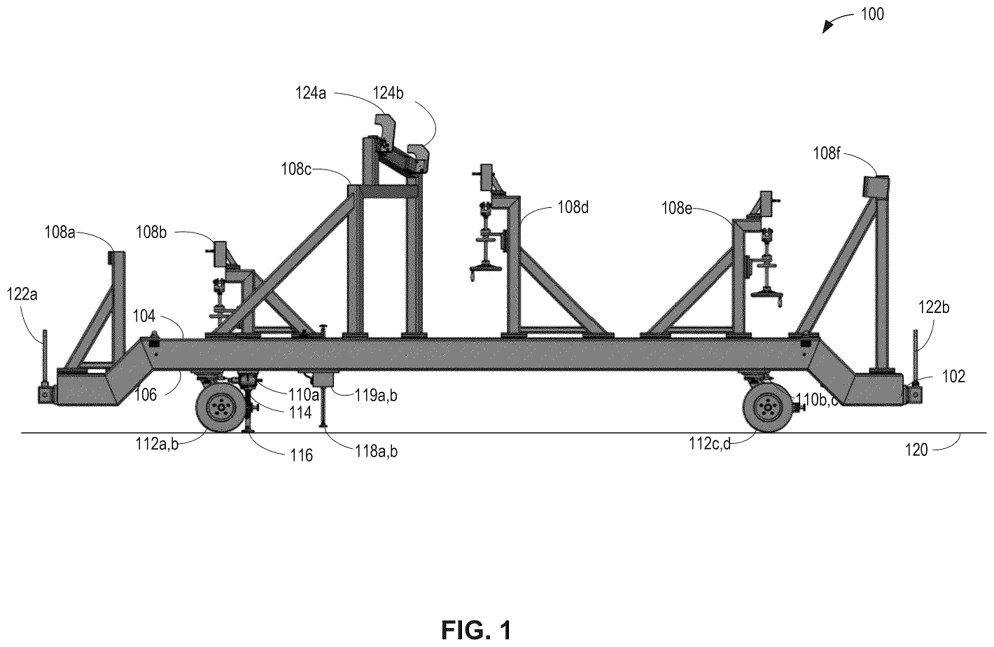

FIG. 1 is a side view of the assembly jig 100 of FIG. 1 to facilitate assembly of an object. The assembly jig 100 includes a frame 102 (e.g., fixture). The frame 102 is a base where structures for support of the object for assembly and structures for creation of the repeatable plane are connected and/or housed. Further, the frame 102 can include other types of structures based on the desired function of the frame 102 (e.g., electrical connections, motorized components, etc.). The frame 102 can be made out of any deformation-resistant material, such as steel. Further, the frame 102 can be any shape (e.g., triangular, square, circular, etc.) and/or size. The frame 102 has a top side 104 and a bottom side 106. The top side 104 includes structure 108a-f to support the object for assembly. The structure 108a-f, as illustrated in FIG. 1, may vary from the illustration of FIG. 1 based on the object to be assembled (e.g., includes one or more structure 108a-f, the structure 108a-f is adapted to the object to be assembled (e.g., includes straps, mounts, etc.), the structure 108a-f is placed in different positions (e.g., in the middle of the top side 104 of the frame 102, mounted to a lateral side of the frame 102, etc.), etc.).

The bottom side 106 defines three support locations 110a-c (e.g., support points). The support locations 110a, 110b, 110c (e.g., a first one of the three support locations, a second one of the three support locations, and a third one of the three support locations, respectively) define the positions of implements to support the weight of the assembly jig 100 and/or stabilize the orientation of the assembly jig 100. As described below, the implements of the support locations 110a-c can include casters, jacks, feet, and any other supporting implement. The implements of the support locations 110a-c can exert a force on a ground surface 120 so that the implements support the weight of the assembly jig 100. The implements can be engaged by hydraulic, pneumatic, manual, and other similar methods to support the weight of the frame 102. The implements at the support locations 110a-c can support the weight of the frame 102 equally or unequally based on the placement of the object for assembly with respect to the frame 102, the orientation of the frame 102 with respect to the ground surface 120, etc.

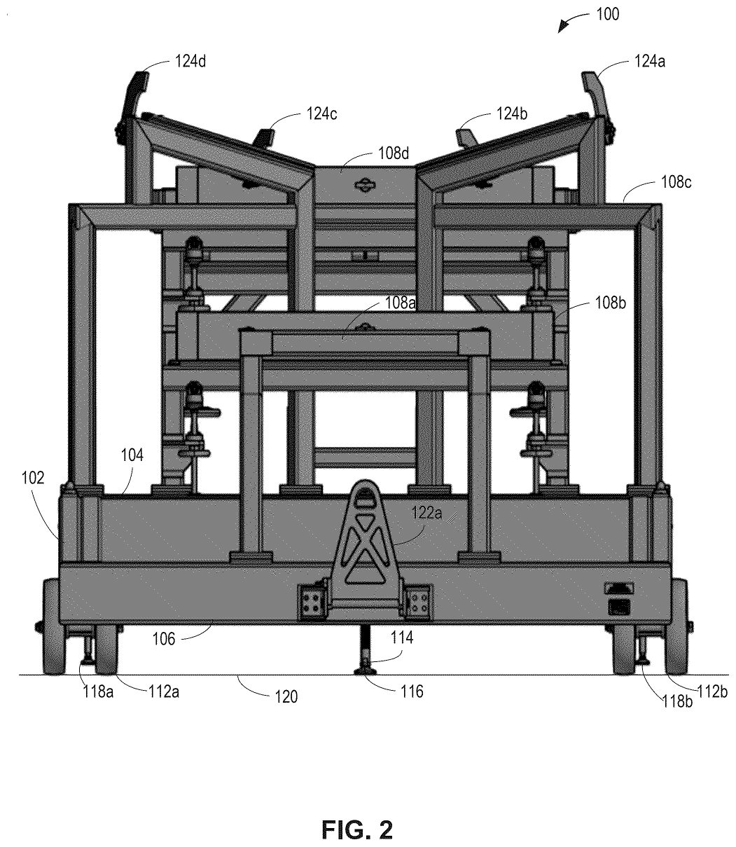

The assembly jig 100 includes casters 112a-d coupled to the bottom side 106 of the frame 102 to enable movement of the assembly jig 100. When the casters 112a, 112b, 112c, and 112d (e.g., a first one of the casters, a second one of the casters, a third one of the casters, a fourth one of the casters, etc.) of the assembly jig 100 are in contact with the ground surface 120, the assembly jig 100 is in a portable condition. In the example of FIG. 1, four casters 112a-d are shown, but in other examples, one caster, two casters, three casters, or more than four casters can be utilized. In the illustrated example of FIG. 1, casters 112a and 112c are visible. However, in other perspective views (such as in FIGS. 2-4) casters 112b and 112d are visible. In the illustrated example of FIG. 1, the casters 112a-d are implemented. However, in other examples, the casters 112a-d can be wheels, rollers, air floats, or any other implement to enable transportation of the assembly jig 100. As shown in FIG. 1, the casters 112c and 112d are attached to the support locations 110b and 110c. In other examples, the casters 112a and 112b can be attached to the support locations 110b and 110c and/or other support locations. Further, in some examples, any combination of casters (e.g., casters 112a and 112c, casters 112b and 112d, casters 112a and 112d, casters 112b and 112c, etc.) can be attached to the support locations 110b,c.

The assembly jig 100 includes a jack 114 coupled to the bottom side 106 of the frame 102. The jack 114 is coupled to one of the three support locations 110a (e.g., a first support location). The jack 114 extends a foot 116 towards the ground surface 120 on which the assembly jig 100 is located. The jack 114 can extend a variable distance based on the angle of the ground surface 120 and the desired angle of the frame 102 relative to the ground surface 120. The jack 114 can utilize a manually operated screw, a pneumatic actuator, a hydraulic actuator, and/or an electric motor to extend the foot 116.

The extension of the foot 116 of the jack 114 causes at least one of the casters 112a,b to be raised above the ground surface 120. In some examples, both casters 112a,b are raised above the ground surface 120 because of the extension of the foot 116 of the jack 114. When at least one of the casters 112a,b is above the ground surface 120 due to the extension of the foot 116 of the jack 114, the assembly jig 100 is in a parked condition. When the assembly jig 100 is in the parked condition, the casters 112c,d and the jack 114 support the weight (e.g., the entire weight) of the assembly jig 100 at the support locations 110a-c. In some examples, the casters 112a,b are above the ground surface when the assembly jig 100 is in the parked condition. In still other examples, there can be more than one jack 114. In these examples, a parked condition can include when the casters 112c and/or 112d are raised above the ground surface 120, alternatively and/or additionally to the casters 112a,b being raised above the ground surface, due to the extension of more than one jack 114. When the assembly jig 100 is in the parked condition, a plane can be created such that the top side 104 of the frame 102 is a flat, or horizontal surface.

As a result of the plane created by the assembly jig 100 in the parked condition, the object for assembly, resting on the structure 108a-f, is held at a consistent position to enable repeatable tooling. As used herein, repeatable tooling includes repeated actions (e.g., adjusting, tightening, fastening, etc.) performed on the object that require precise measurements (e.g., with respect to each other, with respect to the ground surface, etc.). In some examples, the assembly jig 100 can be utilized for calibration to enable precise calibration of the object for assembly and/or a tool placed on the structure 108a-f. In some examples, the assembly jig 100 is used to calibrate a tool as it produces a horizontal plane upon which precise measurements for calibration can be taken.

The assembly jig 100 further includes at least one stabilizer foot 118a (e.g., support). The stabilizer foot 118a (e.g., a first stabilizer foot) is visible in the perspective of FIG. 1. However, in other perspective views (such as FIGS. 2-4), another stabilizer foot 118b (e.g., a second stabilizer foot) is visible. In some examples, the stabilizer foot 118b is spaced apart from the stabilizer foot 118a by a distance to stabilize the frame 102 relative to the ground surface due to a characteristic of the object for assembly (e.g., the object for assembly is heavier on one side, the object for assembly is placed more towards one side of the frame 102, etc.). The stabilizer feet 118a,b are to extend to contact the ground surface 120 in the parked condition to stabilize the orientation of the frame 102 relative to the ground surface 120. Therefore, the stabilizer feet 118a,b stabilize the plane provided by the assembly jig 100 in the parked condition so that weight can be applied by the object for assembly without causing distortion in the plane of the assembly jig 100. In some examples, the stabilizer foot 118a,b is operatively coupled to a shaft lock 119a,b to fix a position of the at least one stabilizer foot 118a,b. The shaft lock 119a,b squeezes the stabilizer foot 118a,b to prevent the stabilizer foot 118a,b from translating. In some examples, the shaft lock 119a,b is a clamping collet that clamps the stabilizer foot 118a,b to prevent translation. In some examples, the stabilizer foot 118a,b has a substantially infinite mechanical resolution to enable the extension of the stabilizer foot 118a,b any distance to the ground surface 120. In some examples, the stabilizer foot 118a,b does not exert any force to hold the weight of the assembly jig 100.

The assembly jig 100 further includes hitches 122a,b. The hitches 122a,b can be used to connect the assembly jig 100 to other implements to allow for towing and/or pulling of the assembly jig 100 to another location.

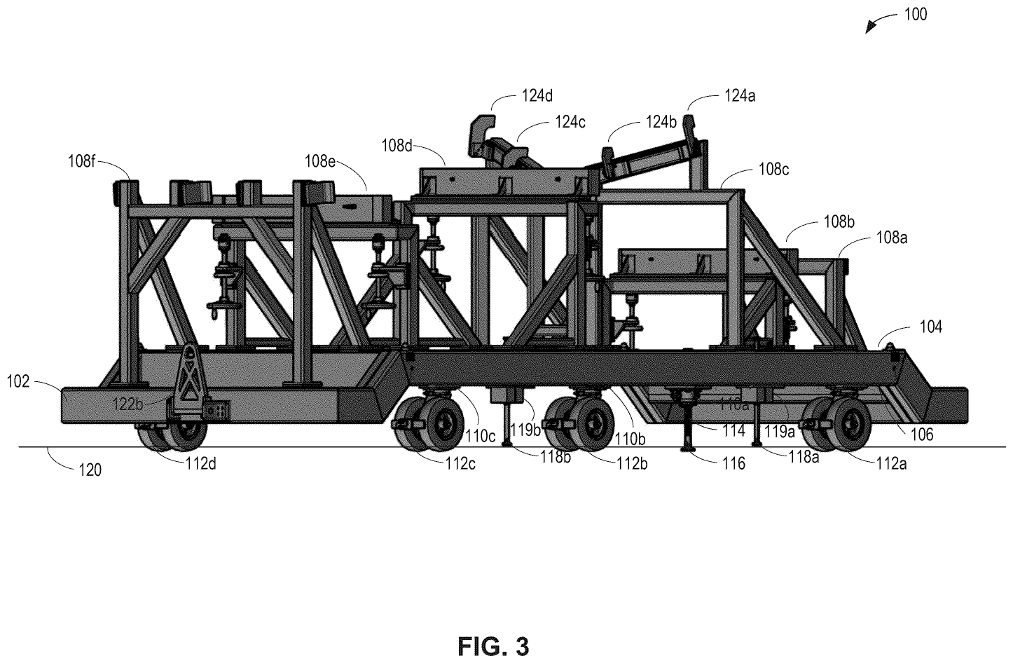

The assembly jig 100 further includes mounting supports 124a-d coupled to the structure 108c. In the illustrated example of FIG. 1, the mounting supports 124a and 124b are visible. However, in other perspective views (such as in FIGS. 2-3) mounting supports 124c and 124d are visible. In some examples, the mounting supports 124a-d hold the object to be assembled in a predetermined location to allow for repeatable tooling. While the mounting supports 124a-d are located on the structure 108c in FIG. 1, in other examples the mounting supports 124a-d can be located at other positions on the assembly jig 100. In this example, the mounting supports 124a-d are hooks, but, in other examples, the mounting supports 124a-d can include fasteners, tie-downs, latches, and other suitable holding implements.

FIG. 2 is a front view of the assembly jig 100 of FIG. 1. The view of FIG. 2 is a head-on view of the hitch 122a. In the view of FIG. 2, the casters 112a and 112b are visible. Additionally, the stabilizer foot 118b (e.g., the second stabilizer foot) is visible. In some examples, there may be one stabilizer foot or more than two stabilizer feet. In this example, the stabilizer feet 118a and 118b are positioned to stabilize the orientation of the frame 102 during assembly of the object (e.g., to prevent lateral displacement due to the weight of the object and/or placement of the assembly jig 100). In some examples, the stabilizer feet 118a and 118b do not exert a force onto the ground surface 120 to support the weight of the frame 102 and/or the object for assembly. Further, in the illustrated example of FIG. 2, the mounting supports 124c and 124d are visible. While in FIG. 2 there are four mounting supports 124a-d, there may be any number of mounting supports to support the object being assembled.

FIG. 3 is a side perspective view of the assembly jig 100 of FIG. 1. The view of FIG. 3 is a skewed view of the frame 102 from the hitch 122b. In the view of FIG. 3, the four casters 112a-d are visible. Additionally, the two stabilizer feet 118a and 118b are visible. Further, the three support locations 110a-c on the bottom side 106 of the frame 102 are visible.

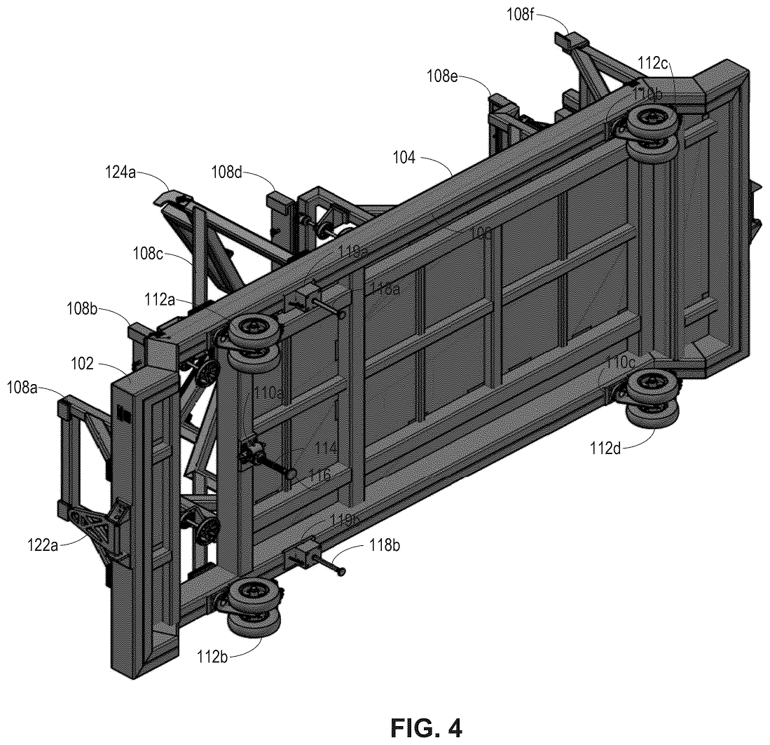

FIG. 4 is a bottom perspective view of the assembly jig 100 of FIG. 1. In the view of FIG. 4, three support locations 110a-c are visible. The three support locations 110a-c are where the stabilizer feet 118a-b and the jack 114 attach to the bottom side 106 of the frame 102. In some examples, there may be one support location, two support locations, and/or more than three support locations.

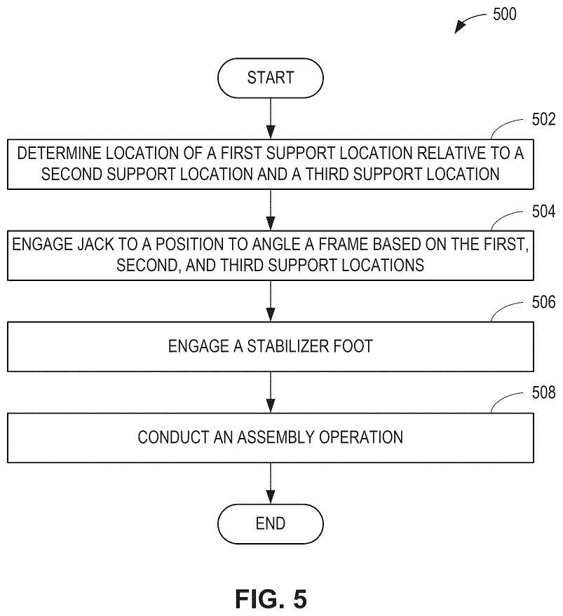

FIG. 5 is a flowchart of a method 500 of operation of the assembly jig 100 of FIG. 1. While the method 500 is shown in FIG. 5, there may be other methods of operation that may additionally and/or alternatively be used to operate the assembly jig 100. The method 500 can be implemented by a user, an actuator, processor circuitry, and/or another implement.

The method 500 starts at block 502 by determining a location of a first support location (e.g., such as the first support location 110a of FIGS. 1-4) relative to a second support location (e.g., such as the second support location 110b of FIGS. 1-4) and a third support location (e.g., such as the third support location 110c of FIGS. 1-4). In this example, the first support location 110a includes the jack 114. Further, the second support location 110b and the third support location 110c include the casters 112c and 112d. By determining the location of the first support location in relation to the second support location and the third support location, the orientation of the first support location relative to the second and third support locations can be found. Therefore, after the location of the assembly activity is determined, the assembly jig 100 can be adjusted to an angle of the ground surface 120. The orientation of the first support location relative to the second and third support locations determines adjustments to be made to the leveling jack to set a plane of the frame 102 for assembly of the object.

At block 504, the jack 114 is engaged to position the frame 102 at an angle based on the first support location 110a, the second support location 110b, and the third support location 110c. The frame 102 can be positioned as a flat surface so that the top side 104 of the frame 102 is horizontal. The jack 114 is engaged to establish complete support of the frame 102 at the first support location 110a, the second support location 110b, and the third support location 110c.

At block 506, a stabilizer foot (e.g., such as the stabilizer foot 118a,b of FIGS. 1-4) is engaged. In some examples, there may be one stabilizer foot, or more than two stabilizer feet. In some examples, the stabilizer foot does not exert pressure onto the ground to hold the weight of the assembly jig.

At block 508, an assembly operation is conducted. The assembly operation can use the structure and mounting supports of FIGS. 1-2. Further, the assembly operation can include at least one of assembling an object, adjusting an object, calibrating a tool, and other assembly operations. The frame is held in a stationary location to enable repeatable precision tooling of the object. Therefore, at any location, the assembly jig can be implemented to create a level plane for the assembly of the object despite the condition of the ground surface that the assembly jig is located on.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

From the foregoing, it will be appreciated that example systems, apparatus, articles of manufacture, and methods have been disclosed for a portable assembly jig that creates a horizontal plane at any location for repeatable, precision tooling.

Example 1 includes a portable assembly jig for facilitating assembly of an object, the assembly jig comprising a frame having a top side and a bottom side, the top side including structure to support an object being assembled, the bottom side defining at least three support locations, three of the support locations to fully support a weight of the assembly jig in a parked condition, assembly of the object to occur in the parked condition, casters coupled to the frame to enable movement of the frame in a portable condition, a jack coupled to at least one of the three support locations such that extension of a foot of the jack toward a ground surface on which the assembly jig is located causes at least one of the casters to be above the ground surface and the assembly jig to be in the parked condition, and at least one stabilizer foot coupled to the frame, a first stabilizer foot to extend to contact the ground surface in the parked condition to stabilize the frame relative to the ground surface.

Example 2 includes the assembly jig of example 1, wherein a first one of the casters and a second one of the casters are respectively coupled to a first one of the three support locations and a second one of the three support locations.

Example 3 includes the assembly jig of example 2, wherein a third one of the casters is coupled to a third one of the three support locations, the third one of the casters is moved above the ground surface in the parked condition.

Example 4 includes the assembly jig of example 1, wherein the jack includes a manually operated screw, a pneumatic actuator, a hydraulic actuator or an electric motor to extend the foot of the jack.

Example 5 includes the assembly jig of example 1, wherein the at least one stabilizer foot is operatively coupled to a clamping collet to fix a position of the at least one stabilizer foot.

Example 6 includes the assembly jig of example 1, further comprising a second stabilizer foot, spaced apart from the first stabilizer foot.

Example 7 includes the assembly jig of example 1, wherein the structure to support an object being assembled includes at least one mounting support to hold the object in a predetermined location.

Example 8 includes an apparatus to facilitate assembly of an object, the apparatus comprising a frame having a top side and a bottom side, the top side including structure to support the object being assembled, the bottom side defining three support locations to fully support a weight of the apparatus during assembly of the object, a jack coupled to at least one of the three support locations such that extension of a portion of the jack toward a ground surface on which the apparatus is located causes the frame to be raised relative to the ground surface, and at least one means for stabilizing coupled to the frame, first means for stabilizing to extend to contact the ground surface to stabilize the frame relative to the ground surface.

Example 9 includes the apparatus of example 8, wherein casters are coupled to the frame, and a first one of the casters and a second one of the casters are respectively coupled to a first one of the three support locations and a second one of the three support locations.

Example 10 includes the apparatus of example 9, wherein a third one of the casters is coupled to a third one of the three support locations, the third one of the casters is moved above the ground surface in a parked condition.

Example 11 includes the apparatus of example 8, wherein the jack includes a manually operated screw, a pneumatic actuator, a hydraulic actuator or an electric motor to extend the portion of the jack.

Example 12 includes the apparatus of example 8, wherein the at least one means for stabilizing is operatively coupled to a clamping collet to fix a position of the at least one means for stabilizing.

Example 13 includes the apparatus of example 8, further including second means for stabilizing, spaced apart from the first means for stabilizing.

Example 14 includes the apparatus of example 8, wherein the structure to support an object being assembled includes at least one mounting support to hold the object in a predetermined location.

Example 15 includes an apparatus to facilitate assembly of an object, the apparatus comprising a fixture having a top side and a bottom side, the top side including structure to support an object being assembled, the bottom side including at least three support points, casters coupled to the fixture to enable movement of the fixture, a jack coupled to at least one of the three support points such that extension of the jack toward a surface on which fixture is located causes at least one of the casters to be above the surface, wherein the three support points support an entire weight of the fixture after extension of the jack, and at least one support coupled to the fixture, a first support to extend to contact the surface after extension of the jack to stabilize the fixture relative to the surface.

Example 16 includes the apparatus of example 15, wherein a first one of the casters and a second one of the casters are respectively coupled to a first one of the three support points and a second one of the three support points.

Example 17 includes the apparatus of example 16, wherein a third one of the casters is coupled to a third one of the three support points, the third one of the casters is moved above the surface in a parked condition.

Example 18 includes the apparatus of example 15, wherein the at least one support is operatively coupled to a clamping collet to fix a position of the at least one support.

Example 19 includes the apparatus of example 15, further comprising a second support, spaced apart from the first support.

Example 20 includes the apparatus of example 15, wherein the structure to support an object being assembled includes at least one mounting support to hold the object in a predetermined location.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A portable assembly jig for facilitating assembly of an object, the assembly jig comprising:
a frame having a top side and a bottom side, the top side including structure to support an object being assembled, the bottom side defining at least three support locations, three of the support locations to fully support a weight of the assembly jig in a parked condition, assembly of the object to occur in the parked condition;
casters coupled to the frame to enable movement of the frame in a portable condition;
a jack coupled to at least one of the three support locations such that extension of a foot of the jack toward a ground surface on which the assembly jig is located causes at least one of the casters to be above the ground surface and the assembly jig to be in the parked condition; and
at least one stabilizer foot coupled to the frame, a first stabilizer foot to extend to contact the ground surface in the parked condition to stabilize the frame relative to the ground surface.

2. The assembly jig of claim 1, wherein a first one of the casters and a second one of the casters are respectively coupled to a first one of the three support locations and a second one of the three support locations.

3. The assembly jig of claim 2, wherein a third one of the casters is coupled to a third one of the three support locations, the third one of the casters is moved above the ground surface in the parked condition.

4. The assembly jig of claim 1, wherein the jack includes a manually operated screw, a pneumatic actuator, a hydraulic actuator or an electric motor to extend the foot of the jack.

5. The assembly jig of claim 1, wherein the at least one stabilizer foot is operatively coupled to a clamping collet to fix a position of the at least one stabilizer foot.

6. The assembly jig of claim 1, further comprising a second stabilizer foot, spaced apart from the first stabilizer foot.

7. The assembly jig of claim 1, wherein the structure to support an object being assembled includes at least one mounting support to hold the object in a predetermined location.

8. An apparatus to facilitate assembly of an object, the apparatus comprising:
a frame having a top side and a bottom side, the top side including structure to support the object being assembled, the bottom side defining three support locations to fully support a weight of the apparatus during assembly of the object;
a jack coupled to at least one of the three support locations such that extension of a portion of the jack toward a ground surface on which the apparatus is located causes the frame to be raised relative to the ground surface; and
at least one means for stabilizing coupled to the frame, first means for stabilizing to extend to contact the ground surface to stabilize the frame relative to the ground surface.

9. The apparatus of claim 8, wherein casters are coupled to the frame, and a first one of the casters and a second one of the casters are respectively coupled to a first one of the three support locations and a second one of the three support locations.

10. The apparatus of claim 9, wherein a third one of the casters is coupled to a third one of the three support locations, the third one of the casters is moved above the ground surface in a parked condition.

11. The apparatus of claim 8, wherein the jack includes a manually operated screw, a pneumatic actuator, a hydraulic actuator or an electric motor to extend the portion of the jack.

12. The apparatus of claim 8, wherein the at least one means for stabilizing is operatively coupled to a clamping collet to fix a position of the at least one means for stabilizing.

13. The apparatus of claim 8, further including second means for stabilizing, spaced apart from the first means for stabilizing.

14. The apparatus of claim 8, wherein the structure to support an object being assembled includes at least one mounting support to hold the object in a predetermined location.

15. An apparatus to facilitate assembly of an object, the apparatus comprising:
a fixture having a top side and a bottom side, the top side including structure to support an object being assembled, the bottom side including at least three support points;
casters coupled to the fixture to enable movement of the fixture;
a jack coupled to at least one of the three support points such that extension of the jack toward a surface on which fixture is located causes at least one of the casters to be above the surface, wherein the three support points support an entire weight of the fixture after extension of the jack; and
at least one support coupled to the fixture, a first support to extend to contact the surface after extension of the jack to stabilize the fixture relative to the surface.

16. The apparatus of claim 15, wherein a first one of the casters and a second one of the casters are respectively coupled to a first one of the three support points and a second one of the three support points.

17. The apparatus of claim 16, wherein a third one of the casters is coupled to a third one of the three support points, the third one of the casters is moved above the surface in a parked condition.

18. The apparatus of claim 15, wherein the at least one support is operatively coupled to a clamping collet to fix a position of the at least one support.

19. The apparatus of claim 15, further comprising a second support, spaced apart from the first support.

20. The apparatus of claim 15, wherein the structure to support an object being assembled includes at least one mounting support to hold the object in a predetermined location.
